(19) United States
(12) Patent Application Publication
(10) Pub. No.: US 2015/0193792 A1
(43) Pub. Date: Jul. 9, 2015

(54) METHOD AND SYSTEM OF GENERATING RELEVANT MARKETING OPPORTUNITIES BY FACILITATING THE COMMUNICATION OF FEEDBACK IN SMALL AND LARGE GROUP SETTINGS

(71) Applicants: Malik Magdon-Ismail, Loudonville, NY (US); Parag Patel, Calabasas, CA (US); Suresh Warrier, Manhattan Beach, CA (US)

(72) Inventors: Parag Patel, Calabasas, CA (US); Suresh Warrier, Manhattan Beach, CA (US); Malik Magdon-Ismail, Loudonville, NY (US)

(21) Appl. No.: 14/149,573

(22) Filed: Jan. 7, 2014

(51) Int. Cl. G06Q 30/02

(52) U.S. Cl. CPC G06Q 30/0203; G06Q 30/0276; G06Q 30/0269

(57) ABSTRACT

A Method And System Of Generating Relevant Marketing Opportunities By Facilitating The Communication Of Feedback In Small And Large Group Settings is provided. With mobile and social networking technologies evolving and the growing need to receive virtually instant feedback from one's social and networking colleagues, the invention provides the ability for a user to send a photograph, video, event information or other form of group message to one or more pre-selected groups, each consisting of two or more members. These groups may be large (e.g. a stadium filled with people) or small (a small classroom). Each member may receive the message through almost instant communications technology and provide a response, which one or more members of the one or more pre-selected groups may view in an engaging results format and continue a group discussion, if desired. In addition, members are presented with native advertisements as part of the user experience and may engage the services of virtual artificial intelligence members in ways beneficial to the group interactions.

### I. CROSS-REFERENCE TO RELATED APPLICATION

This application is related to U.S. Provisional Patent Application 61/513,291 filed on Jul. 29, 2011 and entitled Method And System Of Obtaining Feedback In A Group Setting and to U.S. patent application Ser. No. 13/556,114, filed on Jul. 23, 2012 and entitled Method And System Of Generating Consumer Data By Facilitating The Communication Of Feedback In A Group Setting. This application also claims priority to U.S. Provisional Patent Application 61/750,787 filed on Jan. 9, 2013 and entitled A Method And System Of Generating Relevant Marketing Opportunities By Facilitating The Communication Of Feedback In A Group Setting. The entire disclosures of these applications are hereby incorporated herein by this reference.

### II. STATEMENT RE: FEDERALLY SPONSORED RESEARCH/DEVELOPMENT

Not Applicable

### III. BACKGROUND

The present Invention generally relates to social networking and communications. Worldwide use of the Internet, mobile, instant and delayed communication technology and social networks are growing at an extremely rapid pace. Millions of people worldwide use the Internet through social networking sites and mobile applications daily for accessing information, shopping, recreation, receiving product, news and sports updates, and other communications. As mobile and Internet data access become less expensive, global and easier to use, use of the Internet and mobile communication apps will become even more widespread.

Several communication mobile applications already exist, but none focus on the main elements of the instant invention, namely, obtaining almost instant feedback on virtual anything with minimal number of clicks in a small or large group setting and the ability to obtain data (e.g. the object on which feedback is being provided, surveys conducted in an engaging manner (e.g. sports fans in a live sports arena, a multiple media-poll for shoppers), geo-location of the users providing the feedback, demographic data on the users, and other typically collected forms of data in the internet and mobile area) from a close group of user-selected friends, a larger group or the general public in a manner that entertains, provides a valuable service and presents timely and relevant native advertising opportunities.

Event data (e.g. data related to users intending to watch a favorite sports team playing another team, television shows, movies (especially new releases), theater, opera or other special mass scheduled events) that are created by users using the invention provide additional valuable data as to the viability of products or services and/or present relevant advertising, marketing opportunities and valuable insight into forecasting for supply chains, markets and the like.

In addition to the above, allowing users to obtain feedback easily and almost instantly on images (a pair of shoes sold on an online retail store), website links (news stores, blogs, etc.) or other content (e.g. video clips, music, games, etc.) available on the Internet or other online sources (e.g. online web applications like iTunes) helps the user in making decisions and being entertained and provides the website or content owner with a new source of potential customers (the user and the recipients of the user's poll who, in the example of the shoes above, may view the image of the shoes and be given a link to the webpage) and valuable market research (e.g. how the poll was answered by users, responses broken down into demographical, geographical and other type of audience segments, the current purchasing desires of the users).

While the data feedback described is extremely useful, the main aspects of the instant invention involves the ability to perform highly effective and user-friendly native advertising in connection with the poll-creating and poll-responding social interactions in both small and large groups. There currently exists a problem for social networks to incorporate marketing or advertising material in a manner that is seamless and consistent with the user's use of the social network service. For example, the article “Mobile Ads Are the Future. They're Also Lousy” appearing in the Nov. 5, 2012 issue of Bloomberg Businessweek points out the problem that faced with a “tiny canvas”—the relatively small size of the Smartphone screen—most mobile advertisements (primarily the tiny banner advertisement which has little room to say anything but “Click here for something!” and the interstitial ad that pops up and interrupts the user, thereby annoying the user) have obvious shortcomings. Social Networks, such as Facebook and Twitter, are attempting to introduce advertisements in a native manner (e.g. sponsored stories or promoted tweets) in an attempt to make the advertising process seem a part of the social network experience. However more is needed to make the native-advertising strategy more seamless, effective and less annoying to the user. A Method And System Of Generating Relevant Marketing Opportunities By Facilitating The Communication Of Feedback In Small and Large Group Settings is provided.

### BRIEF DESCRIPTION OF THE DRAWINGS

The invention is herein described, by way of example only, with reference to the following drawings wherein:

FIG. 1 shows a flowchart which provides a method for registering users who wish to access the Service.

FIG. 2 shows a flowchart which provides a method for how a user may create the user's own groups to use the Service.

FIG. 3 shows a flowchart which provides a method for how a user may send out a poll in connection with the Service.

FIG. 4 shows a flowchart which provides a method for how a user may access and edit their preferences for the Service.

FIG. 5 shows an exemplary system for generating consumer data according to one aspect of the present invention.

FIG. 6 provides a step by step portrayal of how a user may select, see and take advantage of a native advertising opportunity using a mobile user interface.

### DETAILED DESCRIPTION OF THE INVENTION

A method of generating consumer data by facilitating the communication of feedback in a group setting over a global data communications network was provided in the above referenced patent application (US Pat. App '114), the method comprising the steps of: enabling at least one initial user to register using a device connected to said global data communications network; enabling said initial user to use said device to invite other users to create a group of users, comprising of initial user and invited users; enabling at least one of said invited other users to register as a group user using a device connected to said global data communications network; enabling at least one of said group of users to create a poll using said group user's device connected to said global data communications network; enabling said group user to send said poll to said group of users by using said group user's device; collecting at least one response to said poll from one or more users in said group; and generating predictive analytical results from one or more responses. Additional steps, such as using an instant notification method (e.g. push notification, SMS messaging, instant alerts), sending the same poll to multiple different groups of friends or to one or more of the poll creator's social networks or sending out a survey (in the form of a series of polls) are also provided.

While not intended as a limitation, it is contemplated that the invention in US Pat. App '114 will partially comprise of a Service provided through an application or number of applications that are executable on various current (e.g. iPhone iOS, android, blackberry, windows phone, symbian) and future mobile platforms, social networks (e.g. Facebook, Google+, Twitter, Pinterest), laptop or desktop computer devices (web applications, browser applications, browser extensions or standalone applications for PC or Mac) and mobile web applications (for unsupported mobile devices or supported mobile devices not running the applicable mobile application). Hence the goal is to make the Service function on as many devices as possible (i.e. application platform independent) and available to any person with any device that has a connection now or in the future to a global data communications network. This network may be of the type provided currently by mobile phone carrier providers and internet service providers around the world (e.g. AT&T, Verizon, Orange, Reliance, China Mobile, cable companies, satellite companies etc.). While the nature of the network and the providers may change in the future, the scope of the invention is intended to cover all current and future types of data networks.

As part of the enhancement to the invention in US Pat. App '114, the present invention contemplates that users will be directly added to friend's group. Once one or more users are in a group, any member of such group may send or receive one or more polls and/or engage in a group chat with the other group members.

In a preferred embodiment in the present invention, a user may create a large or potentially unlimited group without the need to send out invitations or add numerous members by a unique identifier (e.g. an email address or mobile number). Without limiting the foregoing, one method of achieving this result would be for the group creator to provide a code (e.g. made of numbers, letters or other symbols) to potential group members and to have such potential group members enter the code into their mobile or desktop applications in order to join the group. In this manner, a group creator may create a group simply by disseminating a code (e.g. 1234AB); a group creator may have the further option to close a group, keep it open, spread the code to a small group (e.g. few friends sitting with him or her in a classroom setting) or publicly disseminate the code to a large (e.g. a stadium filled with sports fans) group of people. Anyone who receives the code (e.g. a group creator may disseminate the code to recipients in person, by email, website, social network (e.g. Twitter), announcement, public display (e.g. on a large screen in a sports or other live event stadium or theater), broadcast (e.g. to outside viewers in the case of a popular live event)) would be able to enter the code in his or her device and be added to the group.

If a user desires to have only those persons in physical proximity to him or her, then a geo-location filter (using GPS, Bluetooth or other widely available location services) may be placed so only those users close by are able to join a group. This may be done with or without a code (e.g. the group creator creates a group, turns on a join group feature without a code, all users in close proximity (or a user pre-defined proximity) are able to see the group name being transmitted to their devices and such users join the group). These methods make creating a group very easy for large and small groups of people.

The group creator can shut the code or proximate geo-location broadcast to limit the group or keep it open so people can “follow” the group. For example, in a large group, such as one created by a publicly disseminated code (e.g. in a sports or other live public arena), a poll may include, for example, which performer was the best, whether a call by a referee in a sports event was correct, which was the best play of the game, which reality TV star should be ejected, what action to take at a protest rally and the like. The Service provides a quantifiable voice to fans or other public members, whether at the event or viewing on a remote television. Another type of poll may include providing a code to the creator's followers for a specific group. For example, a celebrity may create a public group to vote on the type of clothing she may want to wear by disseminating a code the group through public channels. A research professor may likewise seek other similar minded individuals to provide feedback on a certain intellectual undertaking. In such cases, the celebrity or professor may disseminate a code though well-known channels (blogs, emails, website, social networks, etc.) and keep the group open so interested followers can join the group. In other cases, a group creator may desire to have a closed group. For example a teacher may wish to limit only his or her students in a group and may share a code with the class and then close the group so no-one else may join alter even with the code.

In yet another preferred embodiment, a member of the group may be a Virtual Member (i.e. a non-live or artificial intelligence engine). In many social networks and similar services, most users tend to be passive members and tend to listen to, review or otherwise digest information or other disseminations from a minority of users, typically called the “power-users”. If the members of large numbers of groups are not power-users, then the passive users of such groups may eventually forget about the service and thereby forego the benefits offered by such service. Hence, as part of the Service, the invention contemplates the optional inclusion of a Virtual Member, whose role includes learning the interests of the live members of the group and sending polls or other communications relating to such interests to the group, all of such actions taking place in a manner similar to what a live power-user may have done. Experts in the artificial intelligence field employ commonly-used algorithms and other electronic learning software to enable a virtual group member to participate as anticipated herein. Typically such learning and relevancy of a Virtual Member's interactions will improve over time and with more data relating to the group. Reference is made to the text books, Learning from Data (2012), from the publisher AMLBook and authored by Yaser S. Abu-Mostafa, Malik Magdon-Ismail and Hsuan-Tien Lin and Artificial Intelligence: A Modern Approach (3rd Edition 2009), from the publisher Prentice Hall and authored by Stuart Russell and Peter Norvig, for descriptions of various methodologies that may be employed by experts in the artificial intelligence/machine learning field to enable a Virtual Member and other artificial intelligence engines to accomplish the intentions of the present Invention.

Such Virtual Member may learn from the type of questions, polls, individual biographies, demographics, locations, the history of the group and other characteristics of each group member and of the group as a whole and then use such learned behavior to initiate polls or other communications to the group. For example, for a group interested in restaurants, the Virtual Member may send out a poll to the group about whether or not to try out a new highly rated restaurant. The Virtual Member may provide, via group chat, the location of the restaurant, its menu, ratings and other relevant information. In another example, the Virtual Member may alert a movie-centric group to the initial show times and locations for a popular movie and provide relevant information (e.g. links to reviews, interviews, ticket purchases, memorabilia purchases) via group chat. The Virtual Member may be helpful in countless cases (alerting users to new music, video games, live events, television shows and discussions, etc.) and not just the instances provided above. By initiating a group conversation or poll and/or by adding useful information (by links or otherwise) to an existing conversation or poll, the Virtual Member will keep the other passive users of the group more engaged and entertained, thereby benefiting such users.

If the users of the group prefer not to activate a Virtual Member, then they could chose to have limited artificial intelligence functionality. For example, the Service may still learn group interests in the same way as described above, but instead of having a Virtual Member initiating or participating actively as a group member, the Service provides information (and/or links to useful information) to a live user as such user is creating a post. For example, if a live group member seeks to ask a group which movie to watch, the Service pre-populates in such live group member's chat post or other suitable location, links and/or information (show times, locations, etc.) about the movies being considered. The group member may chose to reject such information, but in most cases, the added information saves such member and other members of the group from researching and sharing the same information.

A poll may include photos, videos, group texts, group chats and event messages. The following examples are not intended as a limitation on the type of poll or number or groups or types of groups to which a poll may be sent: a poll, may include, where to eat, what music to listen to, where to travel or whether a date a potential suitor. The recipients group may include one or more distinct groups created by the poll creator, social networks, followers on other networks, followers of the poll creator, all members using the Service, the entire world, members of a certain demographic or all or some of these aforementioned groups combined.

Typical examples of how a poll creator may use the Service (a typical photo or video poll), a group member may see an object that she may want to purchase (e.g. a red dress) but desires to obtain her “best friends” group's collective feedback before making the purchase. She would launch the app, take a photo of the dress (or photos or videos of several dresses), select an appropriate question (“Which one should I buy or not”), add an optional group message and send out the poll. If the poll creator so desires, she could also send the poll to her friends or followers on a social network (e.g. Facebook, Twitter, Google+). Depending on the alert settings of her “best friends” group and those in her social networks, some or all of her friends are notified instantly or almost instantly and respond back promptly. The results are organized in an engaging visual manner that one or more of the group members and/or social network friends would also be permitted to see based on the poll creator's preferences or the Service's defaults.

In a preferred embodiment, a user would be able to create a poll, based not only on media (e.g. photo or video) taken by the user, but on online content (Online Content) browsed by the user, for example images (e.g. a pair of shoes sold on an online retail store), website links (news stores, blogs, etc.) or other content (e.g. video clips, music, games, etc.) available on the Internet or other online sources (e.g. online web applications like iTunes). For example, a user, seeing an image of a pair of red shoes on an online store, is enabled to show such image and the link of the webpage of the online store, as part of her poll to her friends on whether or not to purchase the shoes. The poll results help the user in making decisions (it also entertains the user and users’ group(s) of friends) and provides the online retail store, in this example, with a new source of potential customers (the user and the recipients of the user's poll) and valuable market research (e.g. how the poll was answered by users, responses broken down into demographical, geographical and other type of audience segments, the current purchasing desires of the users). The above example is not intended to limit the application only to online retail purchases; as indicated above, Online Content (indeed every website or web application intended for public viewing) would benefit from increased traffic and market research.

In a preferred embodiment, a poll creator may allow his or her poll to be shared and re-shared by the recipients with the recipients' groups and/or social network friends and followers, thereby getting even more responders to view and respond to the poll creator's initial poll. In yet another preferred embodiment, a poll creator may, in lieu of or in additional to sending a poll to such user's groups or social network friends, make the poll public to any other user that is interested in following the poll creator, thereby allowing even more responders to respond to the poll. Naturally, the poll creator could also follow and/or respond to the polls of other users of the Service. Poll results may be aggregated or separated by groups (if more than one group of friends is chosen), social networks, followers of the user or by other filter types selected by the user.

In a preferred embodiment, a poll may include an event message. An event message includes any public-scheduled event, for example sports events, movies openings and schedules, arts and music performances, school events, television shows, company events, product launches (e.g. the latest version of a mobile phone), book premiers, signings and the like, that a user has configured on his or her account (which may be accessible through one or more of the user's devices) to receive either manually or automatically (e.g. via download from one or more central servers containing and receiving updated relevant event information). For well-known public events, the user may receive reminders of upcoming events (e.g. a Los Angeles Lakers fan may be sent reminders of an upcoming Lakers game; likewise a movie fan may receive reminders for the opening night of a movie containing a favorite actor, movie type (action, drama, romance), director or genre or other variable important to such user). Typically after receiving an event message (e.g. reminder of an upcoming Lakers game), a user, in the present example, a Lakers fan who has created a Lakers group, may access the service via the application on the user's device, see additional details for the upcoming Lakers game, select it and send a ping to his Lakers group with a question (e.g. See the game at my place or not). He may add an optional group message and then send the Ping to his Lakers group. The remaining members of the group would receive a form of instant communication (e.g. push notification, text message, email etc.), review the question and respond appropriately, all with a minimal number of clicks. Similar obvious scenarios are applicable in other event categories (e.g. asking a group to view a movie during opening weekend, attend a book signing by a famous author or view a popular television show at a member's house).

In yet another preferred embodiment, the group members would also be able to further engage in a group dialogue, if desirable, regardless of sending a photo, video or event poll. In another preferred embodiment, the creator of the poll would be able to send a poll to one or more of his or her groups simultaneously and configure the results to be viewable and the ensuing group discussion to be accessible throughout all members of all groups, only within members of each group or to only certain selected members within a group or across the one or more groups.

The data collected by the service based on such poll communications would be valuable and provide insight into product and service offerings. Users may also be invited or be asked (if they wish to receive further benefits for the application, for example or for other consideration) to participate in various surveys. Such surveys may take a similar form to polls—for example, a user may be presented with several photos and be asked during the sequence to respond to a question relating to each photograph or series of photographs. Likewise a user may be presented with a mix of photos, videos, event information or just plain text questions and be asked to respond to such questions, either individually, collectively or somewhere in between. These types of survey may benefit any entity that sells services or products (e.g. a retailer who may desire to receive market information of types of garments that users across various demographics and geo-locations find attractive (or not) and the amount of money such users would typically agree to pay for such garment). For event coordinators, the buzz created before an event (a sporting event, movie premiere, product launch) may help the promoter in determining where to expect greater (or less) crowds, how much marketing efforts and expenses to continue (especially important for opening movies), and optimizing pricing, among other things. The scope and utility of the types of surveys is potentially huge, and the above examples of type of surveys conducted or how data received from such surveys may be used are not intended to limit such scope.

### V. DESCRIPTION OF THE FIGURES

The figures provided are intended to enable implementation of the invention, and not to limit the manner in which the invention may be implemented. Those skilled in the art may be able to design alternative implementations.

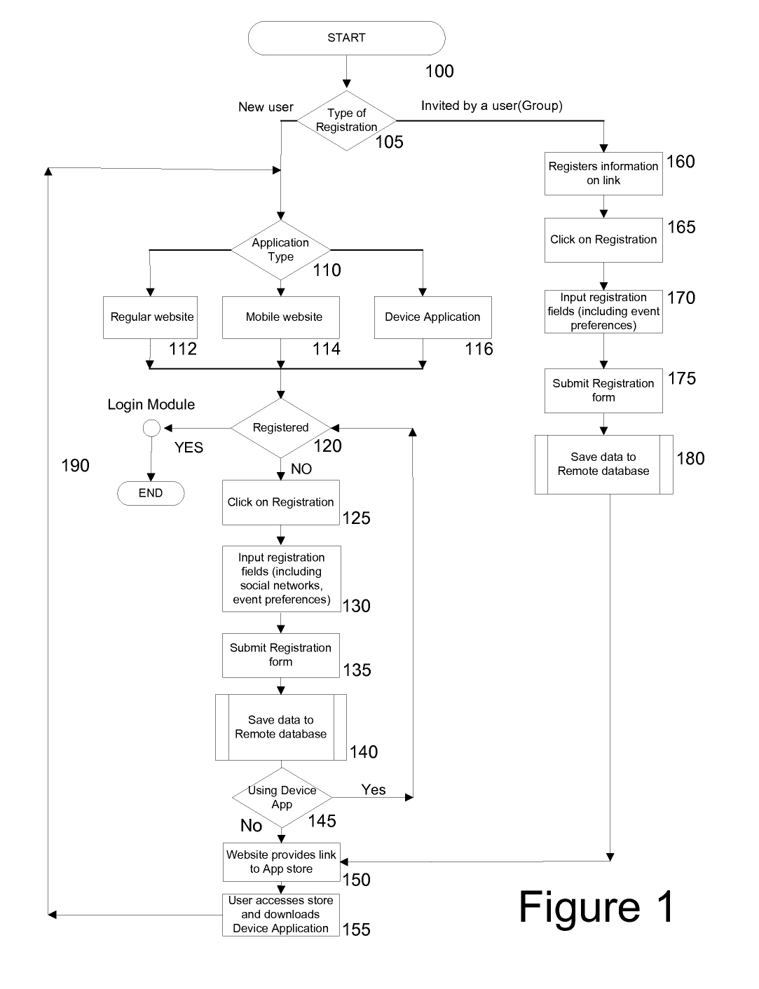

All interactions occur across a Global Communication Data Network which connects the user, using a computer connected to the Internet via a browser (e.g. Internet Explorer) or the user's mobile device (e.g. an iPhone, Android device, Windows phone, feature phones or any mobile device (e.g. an iPod or regular phone) capable of being connected to the Global Communication Data Network, and the Service which may reside across one or more data servers. FIG. 1 provides a possible method for registering users. Upon a user accessing the Service, the Service determines whether the user is a new user or one invited (or added) by another member (105). If a new user, the Service determines if the user is accessing the Service through a Mobile Website, regular website or a Device Application (112-116) and checks against its database to see if the user is registered. If a user is registered, he is she is logged into the service. If not registered, the user is asked to register by entering a unique username and password of if added, the user is asked to complete registration (e.g. by adding just a password—in such cases, the username may be the email or other unique identifier provided by the group creator). Users may also add personal profile information, including demographic information (such as age, age range, gender, occupation, income range, marital status and the like); the user's social network accounts; and event preferences (e.g. if the user is a Lakers fan and would like to receive reminders of a Lakers game) (125-130). The user then submits the registration information (135) which is saved to the Service's databases (140). If the user is already using a Device Application as determined earlier (110), then registration is completed and user may log into the Service (190). If user is not using a Device Application, then user is directed to the appropriate App store for user's mobile device to download and install the appropriate Device Application (150-155). After downloading the Device Application, the user again goes through steps 100-120 and is then able to login to the Service (190).

If the new user is added by another member to join a group within the Service, the added user clicks on a link (sent by email, SMS or other method by the initial user to the added user), enabling the Service to recognize such added member (160). The added user then completes registration by adding a password (if necessary) and is enabled to enter the same type of information that a new user may provide to the Service (165-180). The Service then provides a link for the added user to access the App store and download the appropriate Device Application (150-155).

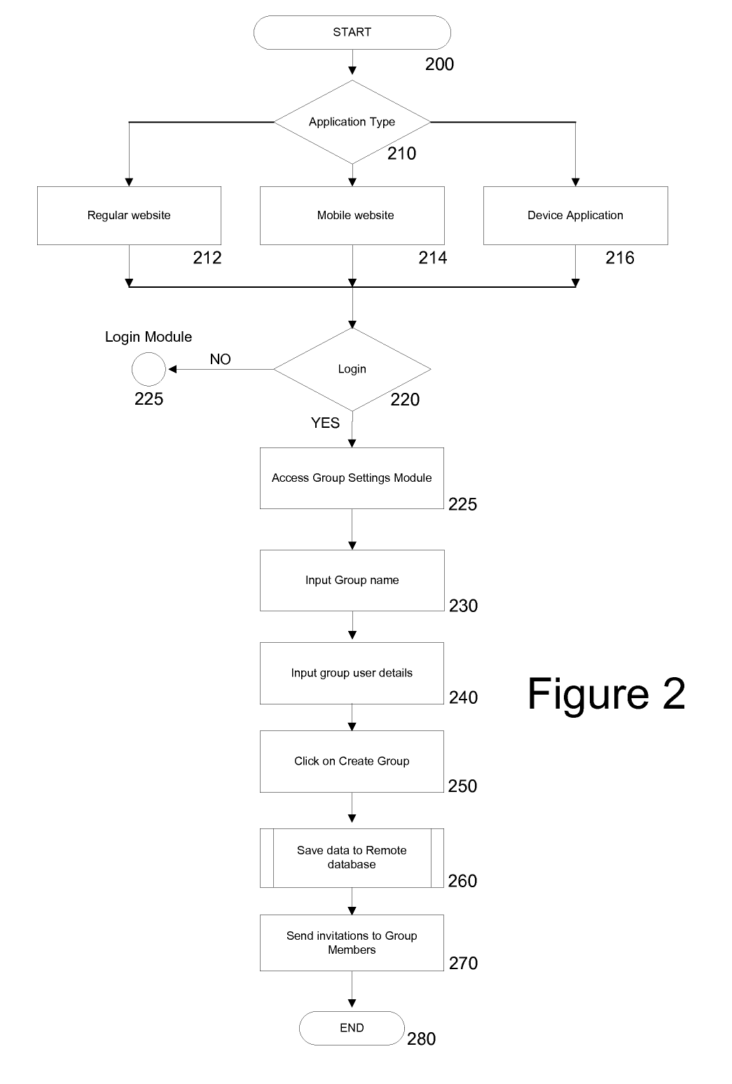

Once a user joins the Service, the user may decide to create the user's own groups within which to exchange polls. FIG. 2 provides such a mechanism. Upon the user accessing the Service, the Service initially determines how the user is accessing the Service (by type of website or Device Application) and then determines whether the user is properly logged into the Service (200-220). If the user is logged on, the user may access the group module (225), input the Group name, invitee or added member details (such as names, email addresses, phone numbers) and create the Group (230-250). The new Group information is stored in the Service's database servers (260) and communications (whether by email, text messages, push notifications or the like) are sent to the added members.

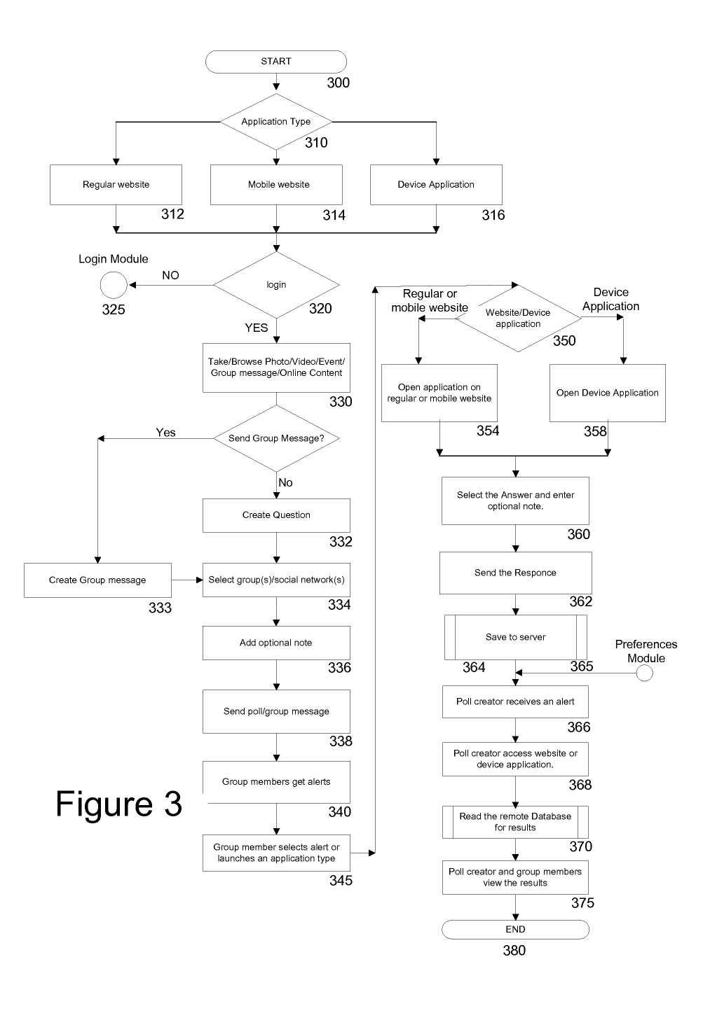

After a user is a member of a group, associated one or more of the user's social networks or has completed registration (i.e. set up a password) and consented to sending public polls, the user may send out a poll as described in FIG. 3. Upon the user accessing the Service, the Service initially determines how the user is accessing the Service (by type of website or Device Application) and then determines whether the user is properly logged into the Service (300-320). If the user is logged on, the user is able to select a photo, video (either previously taken and stored or just taken with the Device's camera), event and/or Online Content, create a question, select one or more private groups, social networks, or the public, add an optional note and send the poll (332-338). Alternatively the user may create only a group message and send it to one or more private groups, social networks, or the public (333-338). The other group members receive alerts (e.g. email, text message, push notification and the like depending on their preferences), launch an application (or their mobile or computer devices), answer the poll, write an optional note and submit their response (340-362). The response is saved to the Service's servers, which then send an alert to the poll creator, who then may access the servers and, along with other group members, review the poll results (364-380).

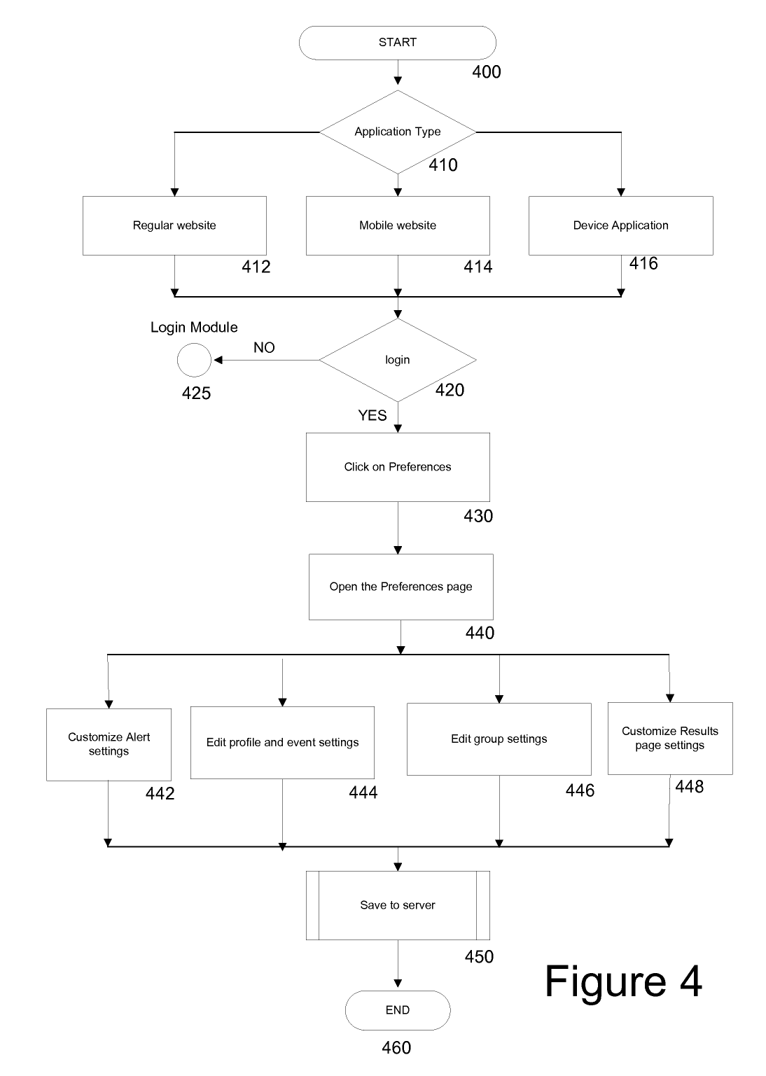

Users may access a separate preferences module on the Service to customize their preference settings. Such a mechanism is shown in FIG. 4. Upon the user accessing the Service, the Service initially determines how the user is accessing the Service (by type of website or Device Application) and then determines whether the user is properly logged into the Service (400-420). The user may then select a preferences menu and review, add or modify the user's preferences as to how to receive alerts, profile information (including demographic information), event settings (add or change subscriptions to event-types), group settings (create new groups, modify current groups, delete groups, add new members, change name of a group or a group's profile, such as group photo) and results settings (430-448). The additions or changes are then stored in the Service's servers (450). Those skilled in the art will know of additional commonly used preference settings for users. Hence the above is not intended as a limitation on what the settings will be for the Service, but an indication of the type of settings that may be useful to a user.

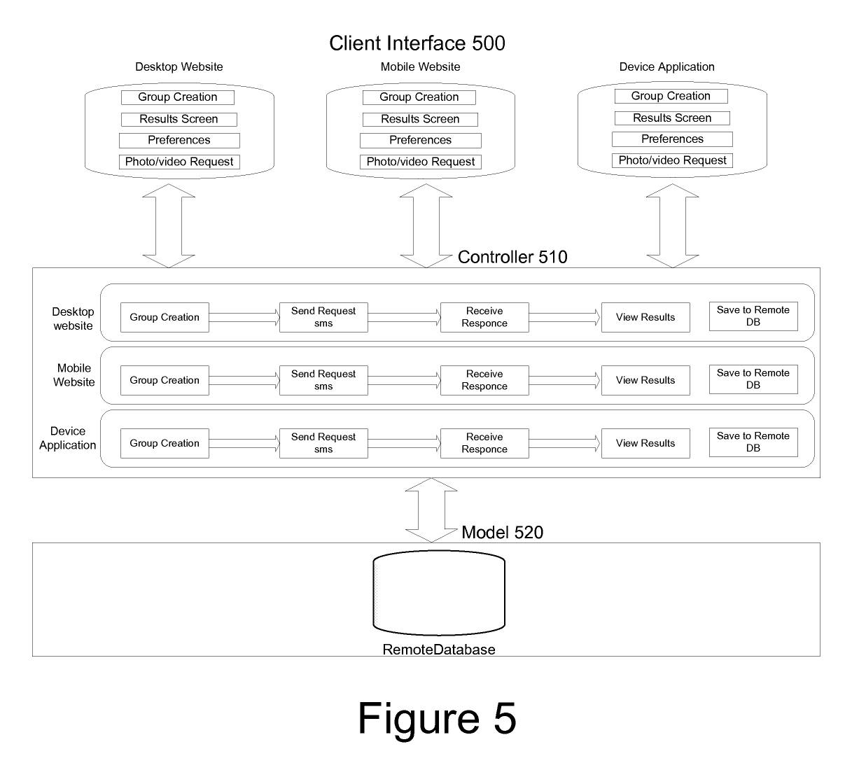

FIG. 5 is a schematic diagram of an exemplary system for generating consumer data according to one aspect of the present invention. It should be appreciated by one skilled in the art that the illustrative embodiment shown in FIG. 5 is one suitable computing environment for the present invention and the method described herein may be implemented in any computing environment.

Any number of users may access the system using a client interface 500. The client interface 500 is the portal of communication between the client device (a mobile phone, computer or other device connected to the Global Data Communications Network) and the host server. On the client side, the client interface 500 is basically a mobile or regular website or device application that is executable on the client device. The client interface 500 provides the users with the ability to engage in the various polling-related transactions (such as the polling, responding and group creating features described herein).

The host server, which may also be a personal computer or set of servers, is configured to execute computer programs for carrying out the methods relating to the various polling related transactions. The host server may comprise a controller engine 510 which is responsible for receiving transaction requests from a client device and communicating the requests, as necessary, for execution by the host server. The transaction engine 510 is responsible for return communication with a client device with regard to status or execution of a polling related transaction.

The host server also comprises a database 520 which stores all data that is kept by the system, including promotional offering provided by vendors. Vendors may access the database through a vendor interface (not shown in FIG. 5, but similar to that of Client Interface 5) that is commonplace in the mobile and online advertising network industries and enables advertisers to input their promotions, keywords, campaign information, spends and other common advertiser inputs. The database may be a standard SQL or other database and is in communication with the controller engine 510 and provides access to data in response to requests received from a client device or through the advertiser interface.

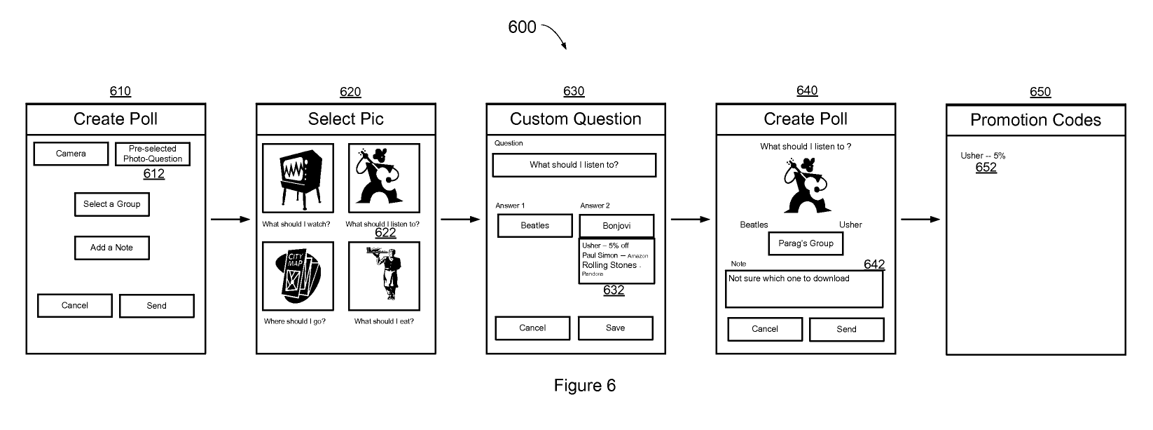

FIG. 6 provides a step by step portrayal of how a user may select, see and take advantage of a native advertising opportunity using a mobile user interface 600. At the initial stage, 610, the user selects a Pre-selected Photo-Question option, 612. The User is taken to mobile interface 620, in which the user makes a selection (622) for a photo-question asking ‘What should I listen to?’ Upon such selection the user is taken to mobile interface 630 in which user enters Answer 1 (Beatles) and Answer 2 (Bonjovi). As the user is selecting Answer 1 and/or 2 and/or edits the question, the user is presented with relevant and selectable advertisement opportunities (Usher, Paul Simon, etc.), 632. The User selects answers and/or opportunities and proceeds with the poll or chat as shown in 640, where the User is also able to add a note, 642. If an advertising opportunity is selected, then the associated promotional code or tag, 652, is stored in the user's device, and may be retrieved at the user's convenience and also may be presented via mobile interface 650 to a merchant from the user's device.

### DETAILED DESCRIPTION OF THE INSTANT INVENTION AND ITS PREFERRED EMBODIMENTS

The instant Invention expands on the capabilities of the invention in US Pat. App '114 in a manner designed to engage the user further and to make the experience more valuable to the user.

In addition to the poll types described in US Pat. App '114 (i.e. photos, videos, group texts and event messages), the instant invention envisions two additional poll types: (i) a provided photo, and (ii) a provided photo and question combination. This is useful in the situation where a user has no obvious photo (either to take using the user's camera or a picture file stored on the user's device) to use for a poll, but desires to send out a non-photo-essential poll (e.g. What time should we meet, What movie should we watch, What song should I listen to, Where are we meeting, Who is coming tonight, etc.). In the case where none of provided questions applies, the user may use the provided photo poll-type and enter a custom question and answers. These are just examples, and not intended to limit the type of provided everyday questions that are useful for the invention. Using these provided poll-types, a user may begin to use the invention in US Pat. App '114 for everyday types of questions and organize the user and his/her friends in connection with everyday typical group activities (e.g. selecting a place to meet, deciding when to meet, agreeing on what to eat, seeing who is coming for an event, etc.).

A further enhancement to the invention in US Pat. App '114 is contemplated hereby when a user picks any poll-type (including, but not limited to, a provided photo/question combo or just photo) and chooses, enters or edits the question and/or answers to the poll. At that point in time, the user may be shown various relevant advertisements that are related to what the user ultimately desires in connection with the poll. Instead of appearing as a banner or other annoying forms of advertisement, the advertising opportunity is presented as a potential answer for the poll in a user-friendly graphical manner. For example, if a user is selecting a place to meet, an opportunity to meet at a nearby coffee shop (location may be determined by the location tracking on the mobile device) may be presented to the user as one of several meeting place options in a pull down menu format (typically seen by a user when conducting internet searches). In some cases, there may be a discount associated with the opportunity (e.g. 10% off if the user buys a drink at the presented coffee shop).

Given the amount of data known about the user as set forth earlier in this application, including but not limited to data relating to the user's friends, past poll responses and results, notes shared, the present question selected, entered or edited by the user, the answer the user is inputting, past purchases of or interest in products or services based on previous advertising opportunities used or saved by the user and user's group members (purchases may be tracked using a coupon code unique to the user or the user's group members and redeemed at a vendor; interest may be tracked by seeing which advertising opportunities a user has saved, but not used), geographic location of the user at the time of entering the answer, demographic information about the user, the photo selected (which is known if a provided photo is selected or may be determined by artificial intelligence photo recognition software), a highly targeted relevant advertisement can be selected for the user and the user's group. Because the relevant advertisement is being shown to the user at the very time that the user is contemplating a decision related to the advertised product or service, the advertisement is extremely useful to the user (helps solve a immediate question) and highly effective (it is the best time to provide a highly relevant advertising opportunity to the user). Also importantly, the offered advertisement opportunity becomes a part of the social network polling experience making it part of an extremely effective native advertising strategy. The user's group members may also see the promotional discounts when they receive the poll photo, question and choice of answers. Each group member is able to vote (as normal), but may also save the promotional offering (in the same manner that the poll-creator is able to save the promotion using the mobile application—see below graphic in paragraph 32) in case the specific offering is of special interest to that group member. In a preferred embodiment, each of the group members responding to the poll may be shown other promotional offerings while they are responding to a poll and able to select and add such new promotional offering to the poll and/or present it to the other group members as part of a group dialogue or chat on the mobile application (see paragraph 15). All promotional offerings may be saved by any of the group members (or anyone who receives the poll, if it is public).

Examples of relevant advertisements in the polling context include choice of movie selections at a nearby cinema if a user is asking a group about which movie to see, choice of nearby restaurants if the user is asking a group where to eat, choice of new hit songs or books if a user is asking about which song to listen to or book to read, discounts at nearby retail or online stores if a user is seeking advice from friends on an item or service to buy. As stated above, the user's selected questions and answers, for example, help substantially in obtaining keywords on what item or service the user is presently looking for and then may be used to find relevant advertisements from advertisers. There are numerous methods commonly known by experts in the area on how to use historic and current data of users to target them with relevant advertisements. The present invention allows the presenting of such opportunities to be done in a way that helps (not antagonizes) the user and at the time that the user is actually seeking help in deciding upon such opportunities. Also, all of the above is done within the context of how the user is using the social network experience, i.e. a native advertising.

In FIG. 6, the user is trying to decide on which song to listen to. When inputting answers, the user is shown a “pull-down” menu (typically seen by internet users when filling in text or search fields) which contains relevant advertisement opportunities related to the type of bands user is considering (e.g. using the first band specified by the user, user's past purchase history or demographics). In addition, some of the choices may include a promotional offering, such as discount from a merchant (the advertiser). If the user selects the choice with the promotional offering (or doesn't select it as an answer, but saves the offering using a check mark or other commonly used mobile user action), the promotional offering is saved within the application. Hence the user is able to retrieve the promotional offering and take advantage of it at a later time. A vendor may use a promotional code, tag, bar code, QR code, an online link (to a website) and the like to track if the user ended up taking advantage of the promotion. Hence the vendor also gets quantitative data on how effective the advertising opportunity was and the vendor's return on investment. The data associated with storing and/or whether or not the user took advantage of the promotion may also be stored and used in future promotional matching for the user and the user's groups.

FIG. 6 provides a step by step portrayal of how a user may select, see and take advantage of the native advertising opportunity explained above. FIG. 6 is provided as an example only, and not intended as any limitation as to how the invention contemplated hereby may be implemented. Experts in the area may find other ways to implement the invention, especially on how to graphically present the advertising opportunity to the user when the user is selecting, entering or editing an answer for the poll that the user is creating. The graphic interface shown below is a typical “pull-down” graphical menu from a text box, but this is provided an example only, and not as a limitation. The invention contemplates the display of an advertisement at the optimal time (when user contemplating the question and answers when creating a poll) and in a manner consistent with the user being able to select the relevant advertisement as a poll answer, all of which occurs as a part of the social experience in creating a group poll. Specifically, FIG. 6 provides a mobile interface 600. At the initial stage, 610, the user selects a Pre-selected Photo-Question option, 612. The User is taken to mobile interface 620, in which the user makes a selection (622) for a photo-question asking ‘What should I listen to?’ Upon such selection the user is taken to mobile interface 630 in which user enters Answer 1 (Beatles) and Answer 2 (Bonjovi). As the user is selecting Answer 1 and/or 2 and/or edits the question, the user is presented with relevant and selectable advertisement opportunities, 632. The User selects answers and/or opportunities and proceeds with the poll or chat. If an advertising opportunity is selected, then the associated promotional code or tag is stored in the user's device, and may be retrieved at the user's convenience and also may be presented via mobile interface 650 to a merchant from the user's device.

Further enhancements, as detailed above, include the generating of various sizes of groups using a code, the use of a Virtual Member in a group and use of a limited Virtual Member in a group which pre-populates relevant information and links while a live member is creating a post in the manner as set forth above.

Apparatus that may be used to perform the above tasks include computers with memory and processors driven by software configured to perform those tasks and access to online communication networks such as the Internet. The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiment.

What is claimed is:

1. A method of generating consumer data by facilitating the communication of feedback in a group setting over a global data communications network, the method comprising the steps of:
enabling at least one initial user to register using a device connected to said global data communications network;
enabling said initial user to use said device to add other users to create a group of users, comprising of initial user and added users;
enabling at least one of said added other users to complete registration as a group user using a device connected to said global data communications network;
enabling at least one of said group of users to create a poll or a group chat using said group user's device connected to said global data communications network;
enabling said group user to send said poll or group chat to said group of users by using said group user's device;
collecting at least one response to said poll from one or more users in said group; and
generating predictive analytical results from one or more responses.

2. The method of claim 1, wherein a group is created by the initial user disseminating a code.

3. The method of claim 2, wherein the initial user has the option to keep on or turn off the said code.

4. The method of claim 1, wherein a group is created using a physical proximity geo-location filter.

5. The method of claim 4, wherein the initial user has the option to keep on or turn off the said proximity geo-location filter.

6. The method of claim 1, wherein at least one of the group members is a Virtual Member.

7. The method of claim 1, wherein information is provided to a user from an artificial intelligence engine while said user is creating a post.

8. The method of claim 1, wherein said poll contains a provided photo.

9. The method of claim 1, wherein said poll contains a provided photo and question combination.

10. The method of claim 1, wherein a poll creator is presented with relevant advertisements as potential responses to the poll that said poll creator is creating.
